(19) United States
(12) Patent Application Publication
(10) Pub. No.: US 2009/0314133 A1
(43) Pub. Date: Dec. 24, 2009

(54) Starter for Start-Stop Cranking System

(76) Inventors: Ravi Atluru, Westland, MI (US); Wei Xue, Northville, MI (US); Martin Jastrzembowski, Brighton, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/143,014

(22) Filed: Jun. 20, 2008

(51) Int. Cl. F02N 15/02

(52) U.S. Cl. 74/7 R

(57) ABSTRACT

An apparatus for cranking an engine that includes a starter motor that includes an armature shaft, a pinion connected to the armature shaft for rotation about an axis, the pinion being able to translate along the axis relative to the armature shaft toward a fixed surface that limits said translation, an engine crankshaft, a ring gear engaged with the pinion and driveably connected to the crankshaft, and a first spring for urging the pinion elastically toward with the fixed surface and the ring gear and elastically resisting axial translation of the pinion away from the ring gear.

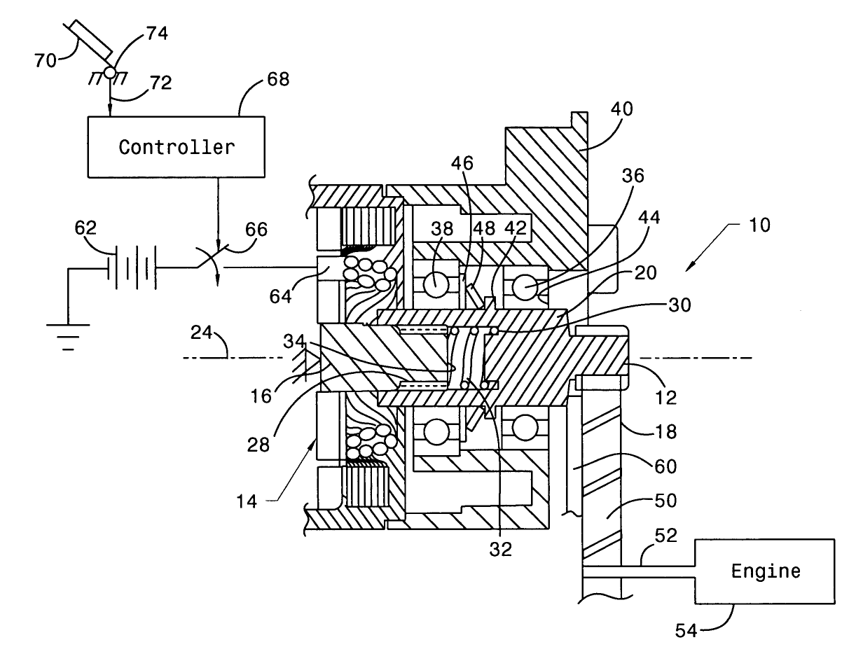

### BACKGROUND OF THE INVENTION

1. Field of the Invention

This invention relates generally to an apparatus for starting an internal combustion engine, and, in particular, to a start-stop engine cranking system.

2. Description of the Prior Art

An electrical starting motor is used to crank and start an engine in an automotive vehicle. Under normal driving conditions, the engine continues to run after it is cranked by the starting motor. To improve fuel economy, a stop-start engine cranking system turns the engine off after the vehicle stops for a predetermined period, and automatically restarts the engine in response to the vehicle operator's depressing the accelerator pedal, which indicates a desire to accelerate the vehicle. These actions occur without need to turn the ignition key either on or off.

In one version of a stop-start engine cranking system a starter pinion is permanently engaged with a ring gear, which is driveably connected to the engine. In that application, the pinion must be precisely located in axial alignment with the ring gear because the pinion and ring gear have helical teeth to reduce gear meshing noise. Due to the helical gears, the force that transmits torque between the engaged teeth has an axially directed component. A large variation in the axial location of the ring gear on the engine crankshaft is present in many vehicles. Yet constant axial contact between starter pinion and ring gear is required for quite reliable operation despite the variation in the axial position of the ring gear on the crankshaft.

A need exists in the industry for a technique that reliably and predictably aligns the starter pinion with the ring gear despite the variation in the axial position of the ring gear on the crankshaft, particularly when helical gear teeth are used.

### SUMMARY OF THE INVENTION

An apparatus for cranking an engine that includes a starter motor that includes an armature shaft, a pinion connected to the armature shaft for rotation about an axis, the pinion being able to translate along the axis relative to the armature shaft toward a fixed surface that limits said translation, an engine crankshaft, a ring gear engaged with the pinion and driveably connected to the crankshaft, and a first spring for urging the pinion elastically toward with the fixed surface and the ring gear and elastically resisting axial translation of the pinion away from the ring gear.

During installation of the starter assembly in a vehicle, the apparatus accommodates variation in the axial location of the ring gear and positions the armature shaft at its desired axial location in the starter motor by providing a compression spring that both urges the pinion axially toward the ring gear and elastically forces the armature shaft against a stop in the motor.

In operation, a second spring, preferably a wave spring, continually urges the pinion elastically toward the ring gear and elastically toward a stop. Contact between the pinion and either the stop or the ring gear limits axial translation of the pinion and ensures its axial alignment with the ring gear.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

The FIGURE is a schematic diagram of an engine starter system including a cross section of an engine cranking assembly.

### DESCRIPTION OF THE PREFERRED EMBODIMENT

Referring now to the drawing, a starter assembly 10 used in a stop-start engine cranking system includes a pinion 12; a starter motor 14; an armature shaft 16 driveably connected to the motor and pinion; a ring gear 18 engaged with the pinion; a sleeve 20 formed the shaft; and two bearings 36, 38. The sleeve 20 and pinion 12 are formed in one piece so that they can translate as a unit along axis 24 and rotate as a unit about axis 24.

The pinion 12-sleeve 20 subassembly, formed in one piece as shown in the drawing, is driveably connected to the armature shaft 16 by an axial spline 28, such that they rotate as a unit about axis 24, but the pinion 12-sleeve 20 subassembly can translate axially relative to shaft 16.

The pinion 12-sleeve 20 subassembly is formed with an internal surface 30 at the end of an axial recess that faces the armature shaft 16. One axial end of a coiled compression spring 32 contacts the axial face 34 of shaft 16 and its opposite end contacts the internal surface 30. The spring 32 is assembled with a compression preload that urges the armature shaft 16 leftward to its correct axial position in the starter motor 14 and urges the pinion 12-sleeve 20 subassembly toward the ring gear 18. Axis movement of the pinion 12-sleeve 20 subassembly is stopped due to contact with a ring gear damping plate 60.

The pinion 12-sleeve 20 subassembly is supported on bearings 36, 38, which are press-fitted in a starter housing 40 and located by shoulders formed on the inside surface of the housing 40. A clearance space always exists between bearing 36 and the axial face of an external shoulder 42 formed on the pinion 12-sleeve 20 subassembly. One side of bearing 38 contacts a ring 46, which is forced by a wave spring 48 axially toward bearing 38. The wave spring 48 contacts the external shoulder 42 on sleeve 20. Preferably spring 48 is a Belleville spring, which may not necessary in some applications

The pinion 12 and ring gear 18 are in continual meshing engagement and are preferably formed with helical teeth. The resultant force between the meshing teeth of the ring gear 18 and pinion 12 has both a radial component, which transmits torque between the meshing teeth, and a thrust component, which is directed along axis 24. Ring gear 18 is secured to a flywheel 50, which is driveably connected to the crankshaft 52 of an engine 54, but there is variation in the axial position of the ring gear 18 when the starter assembly 10 is installed in the vehicle.

The pinion 16-sleeve 20 subassembly can move elastically along the axis 24 of armature shaft 16 subject to the ring gear position and resilient restraint provided by the wave spring 48, which bears against the external shoulder 42 on sleeve 20.

The coiled compression spring 32 forces the pinion 16-sleeve 20 subassembly rightward away from the armature shaft 16, and opposes axial movement of the armature shaft 16, which prevents premature failure of the brushes of motor 14.

The pinion 16-sleeve 20 subassembly is continually urged rightward along axis 24 by compression springs 32 and 48 until the pinion 16-sleeve 20 subassembly contacts damping plate 60, which secured to ring gear 18.

When the starter assembly 10 is assembled in a vehicle, the axial location of the pinion 16 is established by the axial position of the ring gear 18, thereby providing an optimal axial meshing condition.

The starter assembly 10 allows the axial position of pinion 16 to change such that its teeth align with the teeth of the ring gear 18. In a stop-start cranking system, starter pinion 12 permanently engages the ring gear 18, which is secured to engine crankshaft 52.

The system 10 further includes a source 62 of electric power, an armature 64 of the starter motor 14, a switch or relay 66 for opening and closing a connection between power source 62 and armature 64, and a controller 68 for changing the state of the switch. The position of an accelerator pedal 70, i.e., the extent to which the pedal is displaced by the vehicle operator, is represented by a signal 72 produced by a position sensor 74. Controller 68 receives signal 72 as input and determines from that signal whether the operator is causing the engine to idle or is demanding an increase in wheel torque. The controller 68 alternately turns off the engine 54, if it remains in idle mode for a predetermined period, and restarts the engine, when a demand for wheel torque is present.

In normal operation, when switch 62 is closed to crank and start the engine 54, torque is transmitted from starter motor 14, shaft 16, pinion 12, and ring gear 18 to crankshaft 52, causing starter motor 14 to drive pinion 12 about axis 24 and the engine crankshaft 30 to rotate about its axis at a speed that corresponds to the speed reduction produced by the engagement of pinion 12 with ring gear 18. Thus, positive torque is transmitted from the armature 64 of starter motor 14 to the crankshaft 26.

After the speed of crankshaft 52 reaches a speed at which engine combustion can be sustained, combustion of an air-fuel mixture occurs in the combustion chambers of the engine 54, either in response to a spark produced by spark plugs controlled by an engine ignition system, in the case of a gasoline engine, or spontaneously, in the case of a diesel engine.

After sustainable engine ignition occurs, controller 68 opens switch 62, which opens the connection to the electric power source 62, no torque is produced by motor 14, and crankshaft 30 rotates independently of starter shaft 16.

In accordance with the provisions of the patent statutes, the preferred embodiment has been described. However, it should be noted that the alternate embodiments can be practiced otherwise than as specifically illustrated and described.

1. A starter assembly for cranking an engine, comprising:
a starter motor that includes an armature shaft supported for rotation about an axis;
a shaft supporting a pinion, secured to the armature shaft for rotation therewith and translation along the armature shaft;
a ring gear connected to the crankshaft engine and engageable with the pinion; and
a first spring for urging the pinion elastically toward the ring gear and elastically resisting axial translation of the pinion away from the ring gear.

2. The assembly of claim 1 wherein the pinion and ring gear are formed with mating helical gears.

3. The assembly of claim 1 further comprising:
a second spring contacting the armature shaft and the pinion, and urging the pinion elastically toward the ring gear.

4. The assembly of claim 1 further comprising:
a housing;
first and second bearings spaced mutually along the axis and contacting the shaft and the housing, the first spring bearing against the first bearing and the shaft, and urging the shaft and pinion a first axial direction.

5. The assembly of claim 1 further comprising:
a housing;
first and second bearings contacting the shaft and the housing, the first spring bearing against the first bearing and the shaft and resisting translation of the first bearing in a first axial direction;
a second spring contacting the armature shaft and the shaft and resisting translation of the pinion in a second axial direction opposite the first direction; and
the shaft includes a spline that connects the shaft to the armature shaft and permits the shaft to translate axially relative to the armature shaft.

6. An assembly for cranking an engine, comprising:
a starter motor that includes an armature shaft;
a pinion shaft supporting a pinion, secured directly to the armature shaft for rotation therewith and translation along the armature shaft;
first and second bearings contacting and supporting the pinion shaft;
a first spring contacting the pinion shaft and armature shaft, urging the pinion elastically in a first axial direction.

7. The assembly of claim 6 further comprising a second spring producing a force on the first bearing and the pinion shaft, said force resisting translation of the first bearing in a first axial direction and the pinion shaft toward the second bearing.

8. The assembly of claim 6 wherein the pinion is formed with helical gear teeth.

9. (canceled)

10. (canceled)

11. An assembly for cranking an engine, comprising:
a starter motor that includes an armature shaft;
a pinion shaft supporting a pinion, driveably connected by a spline to the armature shaft for rotation therewith and displaceable along the spline relative to the armature shaft;
a first spring contacting the pinion shaft for urging the pinion away from the armature shaft and elastically resisting axial translation of the pinion toward the armature shaft.

12. The assembly of claim 11 wherein the pinion is formed with mating helical gear teeth.

13. The assembly of claim 11 further comprising:
a second spring contacting the armature shaft and the pinion shaft, urging the pinion away from the armature shaft and urging the armature shaft toward an axial position in the starter motor.

14. The assembly of claim 1 further comprising:
a housing;
first and second bearings contacting the shaft and the housing;
a second spring contacting the armature shaft and the shaft and resisting translation of the pinion in a second axial direction opposite the first direction; and
wherein the shaft includes a spline that connects the shaft to the armature shaft and permits the shaft to translate axially relative to the armature shaft.

15. The assembly of claim 11 further comprising:
a housing; and
first and second bearings contacting the pinion shaft and the housing.
